(19) United States
(12) Patent Application Publication
(10) Pub. No.: US 2007/0223774 A1
(43) Pub. Date: Sep. 27, 2007

(54) Coupled body of speaker apparatus

(75) Inventor: Hideaki Sugiura, Tendo-shi (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION, Tokyo (JP); TOHOKU PIONEER CORPORATION, Tendo-shi (JP)

(21) Appl. No.: 11/715,387

(22) Filed: Mar. 8, 2007

(30) Foreign Application Priority Data
Mar. 9, 2006 (JP) P2006-064375

(51) Int. Cl. H04R 9/06; H04R 1/00; H04R 11/02

(52) U.S. Cl. 381/407; 381/400

(57) ABSTRACT

A coupled body of a speaker apparatus having a frame and a vibration unit, the coupled body including a disk which is connected in its inner periphery on a side of the vibration unit and connected in its outer periphery on a side of the frame, the disk having a plurality of corrugations like concentric circles, wherein a first corrugation in the vicinity of the vibration unit is formed to be higher than the plurality of second corrugations other than the first corrugation, and the second corrugations are formed to have identical heights.

### BACKGROUND OF THE INVENTION

1. Field of the Invention

The present invention relates to a technical field of a coupled body of speaker apparatus used in various audio equipments.

2. Related Art

The speaker apparatus has a vibration unit such as a cone and a voice coil bobbin, the vibration unit is connected to a frame of a speaker apparatus through a coupled body in a disk shape. The coupled body is provided between an outer periphery of the cone and the frame of the speaker apparatus, and further provided as a damper between the outer periphery of the voice coil bobbin and the frame of the speaker apparatus. A disk constituting the coupled body has a plurality of corrugations like concentric circles

When a voice signal (e.g. electric signal) is applied to the voice coil to cause a portion of from the voice coil bobbin to the cone vibrate, voice is produced from the speaker apparatus. The disk having the corrugations formed on it allows vibration of the voice coil bobbin, and gradually attenuate vibration of the voice coil bobbin.

According to one type of such a disk, a plurality of the corrugations as described above are typically formed on the disk.

However, in such the disk, there may be a problem that an amplitude is apt to be insufficient in a certain sound range and distortion is apt to be generated.

### SUMMARY OF THE INVENTION

It is therefore an object of an illustrative, non-limiting embodiment of the present invention to provide a coupled body of speaker apparatus which can increase an amplitude in a certain sound range.

According to a first aspect of an illustrative, non-limiting embodiment of the present invention, there is provided a coupled body of speaker apparatus having a disk which is connected in its inner periphery to a vibration unit of a speaker apparatus and in its outer periphery to a frame, wherein

the disk having a plurality of corrugations like concentric circles,

the first corrugation in the vicinity of the vibration unit is formed to be higher than the plurality of second corrugations other than the first corrugation, and the second corrugations are formed to have identical heights.

### BRIEF DESCRIPTION OF THE DRAWINGS

In the accompanying drawings:

FIG. 1 is a cross-sectional view of a part of speaker apparatus according to a non-limiting embodiment (Embodiment 1) of the present invention.

FIG. 2 is an enlarged cross-sectional view showing a part of coupled body including a cone.

FIG. 3 is a graph showing sound pressure—frequency characteristics and second harmonic distortion characteristics in comparison with a coupled body of the speaker apparatus according to a non-limiting embodiment of the present invention and a coupled body of conventional speaker apparatus.

FIG. 4 schematically shows up and down vibrating states of a coupled body and cone of speaker apparatus according to a non-limiting embodiment of the present invention with respect to change of phases in a voice coil bobbin.

FIG. 5 schematically shows up and down vibrating states of a coupled body and cone of a conventional speaker apparatus with respect to change of phases in a voice coil bobbin.

FIG. 6 is an enlarged cross-sectional view showing a part of damper in a speaker apparatus according to a non-limiting embodiment (Embodiment 2) of the present invention.

### DESCRIPTION OF THE PREFERRED EMBODIMENTS

Preferred embodiments of the coupled body of speaker apparatus according to the present invention will be described in reference of figures. Hereinafter, each meaning of the reference numbers in the drawings is as follows: 1: frame, 6: voice coil bobbin, 7: cone, 9: disk, 9a,9b,9c,9d,9e: corrugation, 11: damper, and 11a,11b,11c,11d,11e,11f,11g,11h,11i: corrugation

### Embodiment 1

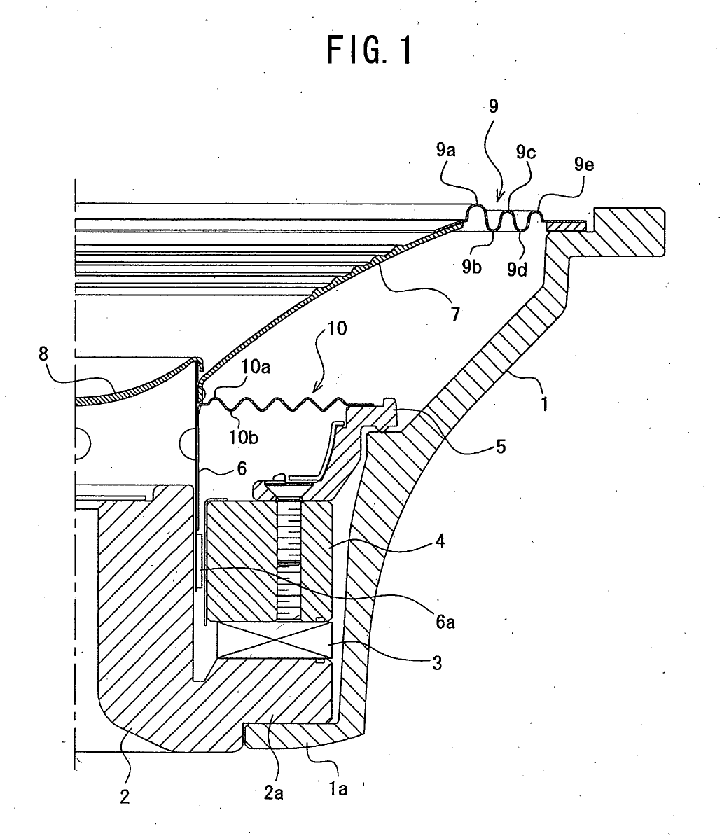

As shown in FIG. 1, the speaker apparatus has a frame 1 in a profile of substantially upside-down frustum of a cone. The speaker apparatus is fixed to a chassis or the like of vehicle via the frame 1.

To a bottom portion of the frame 1, a yoke 2 made from a magnetic substance is fixed. Specifically, a bottom plate 2a protruding from a bottom of the yoke 2 in a direction of its outer periphery like a flange is laid on and fixed to a flange portion 1a of the frame 1. A magnet 3, a yoke plate 4, and a support ring 5 are sequentially piled on the bottom plate 2a of the yoke 2 and fixed thereto. Thus, a part of from the yoke 2 to the support ring 5 is connected to the frame 1 and integrated therein.

In a gap among the yoke 2, the magnet 3, and the yoke plate 4, a cylindrical space is formed. The voice coil bobbin 6 in a cylindrical shape is inserted inside the space. To a point opposite to the yoke plate 4 of the voice coil bobbin 6, the voice coil 6a is fixed. The magnet 3, the yoke 2 below the magnet 3, and the yoke plate 4 above the magnet 3 form a magnetic circuit. When a sound signal is applied as an electric signal to the voice coil 6a of the voice coil bobbin 6, the voice coil bobbin 6 vibrates inside the space as the vibration unit.

To a point of the voice coil bobbin 6 protruding from the yoke plate 4, an inner periphery of the cone as the vibration unit is coupled and fixed. Further, to an upper end of the voice coil bobbin 6 upward protruding from the yoke plate 4, the center cap 8 which forms the vibration unit together with the cone 7 is fixed.

The outer periphery of the cone 7 is coupled to an opening edge of the frame 1 via the disk 9 as the coupled unit. The disk 9 has a plurality of corrugations 9a, 9b, 9c, 9d, and 9e like concentric circles entirely through their radius direction.

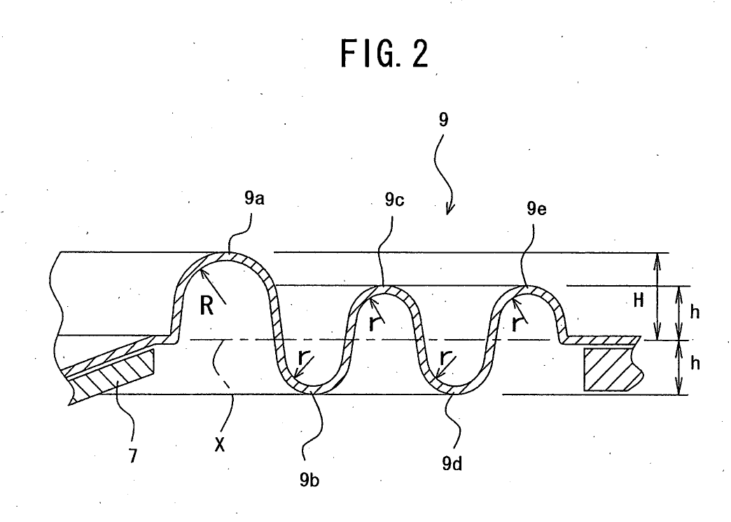

As shown in FIG. 2, these corrugations 9a, 9b, 9c, 9d, and 9e are formed such that the corrugation 9a closest to the cone 7 as the vibration unit is higher than the other corrugations 9b, 9c, 9d, and 9e, i.e. H>h, and the other corrugations 9b, 9c, 9d, and 9e have identical heights h. Further, curvature radii of curved portions of the corrugations 9b, 9c, 9d, and 9e may be identical or different. Preferably, as shown in FIG. 2, a curvature radius of curved portion of the corrugation 9a closest to the cone 7 is R, and curvature radii of curved portions of the corrugation 9b, 9c, 9d, and 9e are r, i.e. R>r.

The curvature radius of curved portion may be a minimum value, maximum value, average value, mean value or the like with respect to each of the corrugations. The curvature radii at corresponding portions in each of the curved portions of the corrugations 9b, 9c, 9d, and 9e may be compared in determining small or large.

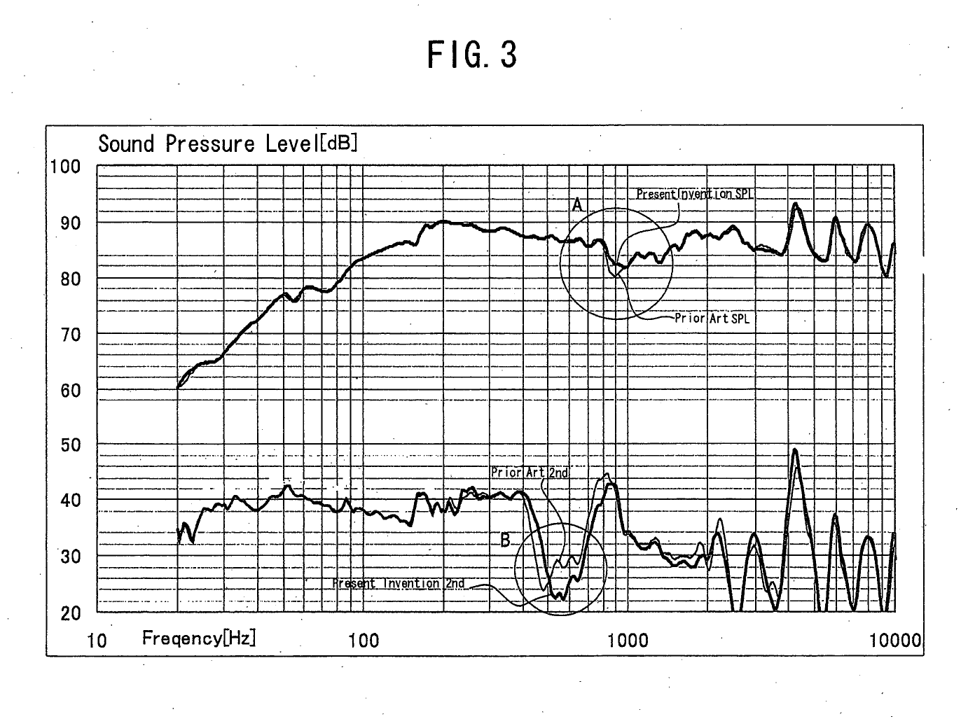

By employing the cone 7 shown in FIG. 2, as shown in FIG. 3, the sound pressure-frequency characteristics and the second harmonic distortion characteristics are improved as shown in FIG. 3. Namely, as to the sound pressure-frequency characteristics, the sound pressure is improved in the vicinity of 900 Hz as indicated inside a circle A, and as to the second harmonic distortion characteristics, a second harmonic distortion is deteriorated around 400 to 900 Hz as indicated inside a circle B.

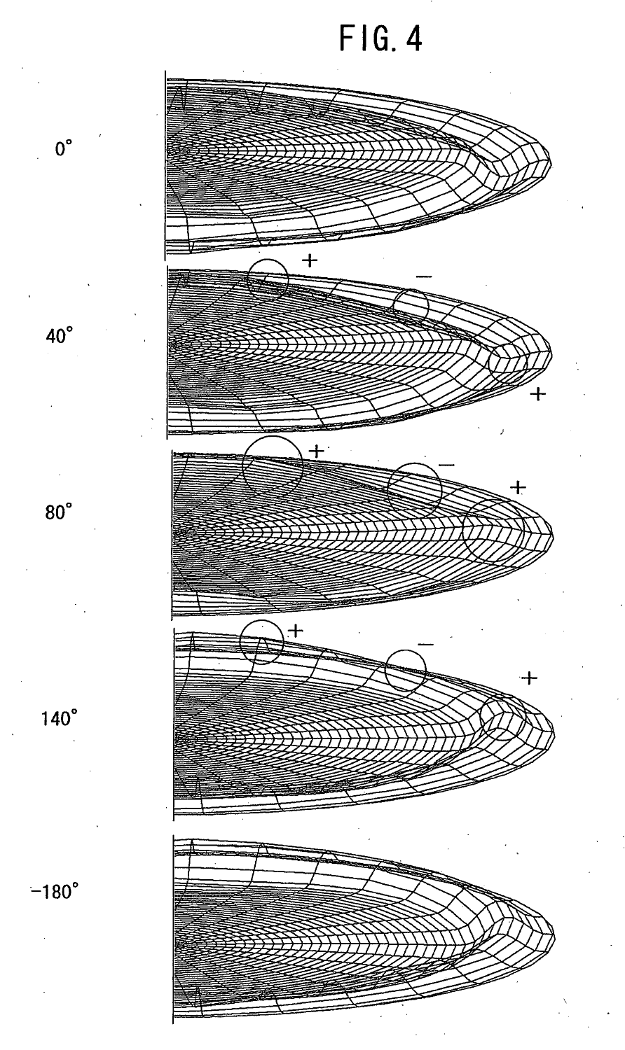

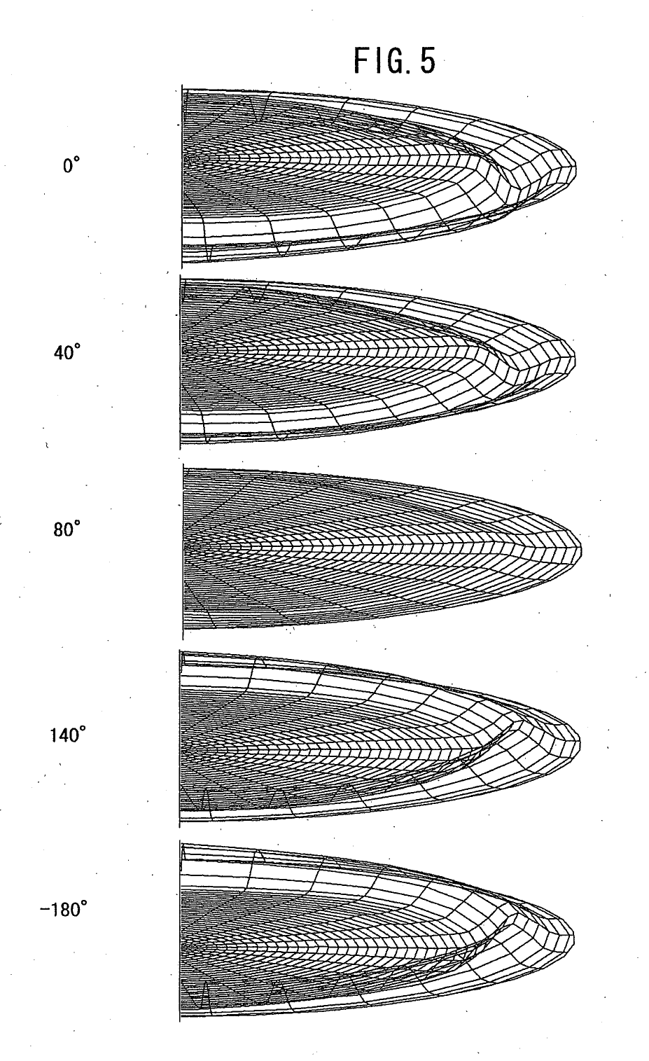

Further, these improvements of the characteristics are outstanding in comparison with FIGS. 4 and 5. FIGS. 4 and 5 are to visualize a vibrating state of the cone 7 in use of 3D mesh. FIG. 4 is related to a case where the coupled body according to the present invention shown in FIG. 2 is employed, and FIG. 5 is related to a case where all corrugations are formed at identical heights and of identical curvature radii. In this, the 3D mesh is displayed on a surface including a dashed line X. Further, in FIGS. 4 and 5, 0 to −180 degrees correspond to various positions in one periodic cycle from a lower most position to an upper most position of the voice coil bobbin 6. Although movement of the cone 7 in FIG. 5 is small, isolated vibration is generated, and adverse sympathetic vibration is obviously decreased in FIG. 4, as alternately showing convex portions (+) and concave portions (−).

As shown in FIG. 1, a damper 10 is provided as the coupled body for coupling the voice coil bobbin 6 as the vibration unit to the frame 1. The inner periphery of the disk forming the damper 10 is fixed to an outer peripheral surface of the voice coil bobbin 6 with for example a bond, and an outer peripheral edge of the disk is fixed to the support ring 5 supported on a side of the frame. The disk of the damper 10 has a plurality of corrugations 10a, 10b . . . like concentric circles entirely through their radius direction. For example, these corrugations have identical heights and formed to be in identical curvature radii.

### Embodiment 2

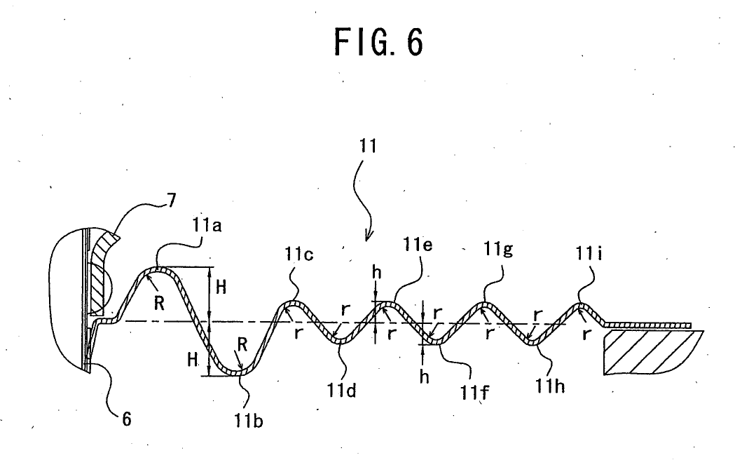

In Embodiment 2, as shown in FIG. 6, corrugations 11a, 11b, 11c, 11d . . . , 11i of a damper 11 are shaped like the coupled body of Embodiment 1.

Namely, a plurality of the corrugations 11a, 11b, 11c, 11d . . . , 11i are shaped like concentric circles on a disk forming the damper 11. Among the plurality of the corrugations, upward and downward corrugations 11a and 11b in the vicinity of a voice coil bobbin 6 as a vibration unit are shaped to be higher than the other corrugations 11c, 11d . . . , 11i apart from the voice coil bobbin 6, i.e. H>h, and the other corrugations are shaped to have identical heights.

Further, as to curvature radii of curved portions of the corrugations 11a, 11b, 11c, 11d . . . , 11i, curvature radii of the curved portions of the corrugations 11a and 11b are R, and those of the corrugations 11c, 11d . . . , 11i are r, wherein R>r.

The curvature radius of curved portion may be a minimum value, maximum value, average value, mean value or the like with respect to each of the corrugations. The curvature radii at corresponding portions in each of the curved portions of the corrugations 11c, 11d . . . , 11i may be compared in determining small or large.

Effects similar to those described in reference of the characteristic diagram of FIG. 3 are obtainable with this damper. Further, the surface indicated by a dashed line in FIG. 6 vibrates in a state as shown in FIG. 4.

In embodiment 2, portions the same as that in Embodiment 1 are indicated by the same numerical references, and redundant explanation is omitted.

The present invention is not confined to the configurations listed in the foregoing embodiments, but it is easily understood that the person skilled in the art can modify such configurations into various other modes, within the scope of the present invention described in the claims.

For example, although the example of applying the present invention to the cone is described in Embodiment 1, it is possible to apply the present invention to the damper. Further, although the example of applying the present invention to the damper is described in Embodiment 2, it is possible to apply the present invention to the cone. The total number of the corrugations is not limited to Embodiments 1 and 2.

The entire disclosures of Japanese Patent Applications No. 2006-64375 filed on Mar. 9, 2006 including the specification, claims, drawings and summary are incorporated herein by reference in its entirety.

What is claimed is:

1. A coupled body of a speaker apparatus having a frame and a vibration unit, the coupled body comprising
a disk which is connected in its inner periphery on a side of the vibration unit and connected in its outer periphery on a side of the frame, the disk having a plurality of corrugations like concentric circles, wherein
a first corrugation in the vicinity of the vibration unit is formed to be higher than the plurality of second corrugations other than the first corrugation, and
the second corrugations are formed to have identical heights.

2. The coupled body of the speaker apparatus according to claim 1, wherein
the first corrugation has a larger curvature radius than those of the second corrugations.

3. The coupled body of the speaker apparatus according to claim 1, wherein
the vibration unit is a cone, and
the disk is interposed between an outer periphery of the cone and the frame.

4. The coupled body of the speaker apparatus according to claim 2, wherein
the vibration unit is a cone, and
the disk is interposed between an outer periphery of the cone and the frame.

5. The coupled body of the speaker apparatus according to claim 1, wherein
the vibration unit is a voice coil bobbin, and
the disk is interposed between an outer periphery of the voice coil bobbin and the frame.

6. The coupled body of the speaker apparatus according to claim 2, wherein
the vibration unit is a voice coil bobbin, and
the disk is interposed between an outer periphery of the voice coil bobbin and the frame.
